(19) United States
(12) Patent Application Publication
(10) Pub. No.: US 2007/0088988 A1
(43) Pub. Date: Apr. 19, 2007

(54) System and method for logging recoverable errors

(75) Inventors: Saurabh Gupta, Federal Way, WA (US); Akkiah Maddukuri, Austin, TX (US); Bi-Chong Wang, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/250,603

(22) Filed: Oct. 14, 2005

(51) Int. Cl. G06F 11/00

(52) U.S. Cl. 714/48

(57) ABSTRACT

In accordance with the present disclosure, a method and system for logging recoverable errors in an information handling system is disclosed. The system includes a central processing unit, a chipset coupled to the central processing unit, and at least one chipset memory unit coupled to and associated with the chipset. The system also includes a Baseboard Management Controller (BMC), and a memory unit containing a Basic Input Output System (BIOS). A System Management Interrupt (SMI) is periodically invoked. A status register is scanned to detect whether a recoverable error has occurred. If a recoverable error is detected, the system logs the recoverable error in a memory unit associated with the baseboard management controller. The system logs information that indicates a source of the recoverable error and that source's location. If no recoverable errors are detected, the system transmits a communication indicating that no recoverable errors have occurred.

### TECHNICAL FIELD

The present disclosure relates generally to computer systems and information handling systems, and, more specifically, to a system and method for logging recoverable errors.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

Server systems can experience recoverable or correctable errors during normal system operation. Such recoverable errors might occur, for example, when memory units coupled to the server system fail. To increase system reliability, server systems are often designed to capture and log recoverable or correctable errors as they occur. Because recoverable errors often are warning signals for impending memory failures, this capture-and-log process gives the server-system user a chance to replace defective memory units before the entire system crashes. Server systems often route errors to be logged by generating a System Management Interrupt (SMI) via sideband signals. The SMI travels through the sideband to the CPU, and the CPU then freezes ongoing server system processes. These pauses in processing caused by the SMI enable the Basic-Input-Output System (BIOS) residing on the server system to log the recoverable errors as they occur, using a SMI handler. Once the BIOS logs the errors, the SMIs end, and the server system may resume performing any interrupted processes. The Baseboard Management Controller (BMC), which manages the interface between system management software and platform hardware, processes the error logging commands received from the BIOS and does the actual writing to its non-volatile memory. Throughout the entire notification process, the operating system (OS) residing on the server system is unaware of the error and subsequent logging of that error.

Some server systems, however, do not include sideband signal capability. All communications must travel through the main transport link. Because recoverable errors are correctible, the server system does not generate a notification when recoverable errors occur. These server systems may thus be designed to report recoverable errors by employing the server system BIOS or the chipset to perform periodic scans, such as periodic SMIs. Similarly, these server systems may require the server-system OS to periodically scan the system. For example, the OS might periodically scan the system and log any recoverable errors that have been detected in the machine check status register. A typical OS will scan about once every minute. Using the server-system OS to periodically scan the system has its drawbacks, however. For example, most hardware errors are system-specific. Typically, however, an OS lacks any understanding of the specific architecture for the system. The OS often cannot identify which component is at fault without seeking help from the system BIOS, thereby tying up both resources. Server system users often require more specificity than a generic error logging performed by an OS, particularly if the system at issue is a high-end server system. Moreover, the OS will often log errors in a machine check status register, which does not store information regarding the error source and therefore does not permit the system or user to later determine the location of that error source. Although some OS versions can maintain a log of as many as ten recoverable errors per scan, typically an OS will disable further logging of recoverable error once this happens, thereby preventing the user from looking at errors over time to determine the source of the problems.

### SUMMARY

In accordance with the present disclosure, a method and system for logging recoverable errors in an information handling system is disclosed. The system includes a central processing unit, a chipset coupled to the central processing unit, and at least one chipset memory unit coupled to and associated with the chipset. The system also includes a Baseboard Management Controller (BMC), and a memory unit containing a Basic Input Output System (BIOS).

A System Management Interrupt (SMI) is periodically invoked. Error status registers are scanned to detect whether a recoverable error has occurred. If a recoverable error is detected, the system logs the recoverable error in a non-volatile memory unit associated with the BMC. The system logs information that indicates a source of the recoverable error and that source's location. If no recoverable errors are detected, the system transmits a communication indicating that no recoverable errors have occurred.

The system and method disclosed herein are advantageous because they allow the information handling system to determine the source of recoverable errors and location of that source, even if the information handling system lacks the capability to send signals via a sideband. The BMC or the BIOS, not the OS, identifies and logs the source of recoverable errors. The system and method disclosed herein are also advantageous because they may allow the periodicity of the SMI to be dynamically adjusted based on an event during operation of the information handling system or a change in operation of the information handling system. The periodic scan can be faster than the OS recoverable-error scanning rate.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a block diagram of an example architecture for an example motherboard;

FIG. 2 is a flowchart illustrating a sample method for adapting the frequency at which the system performs a periodic scan; and

FIG. 3 is a block diagram of an example architecture for an example motherboard.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

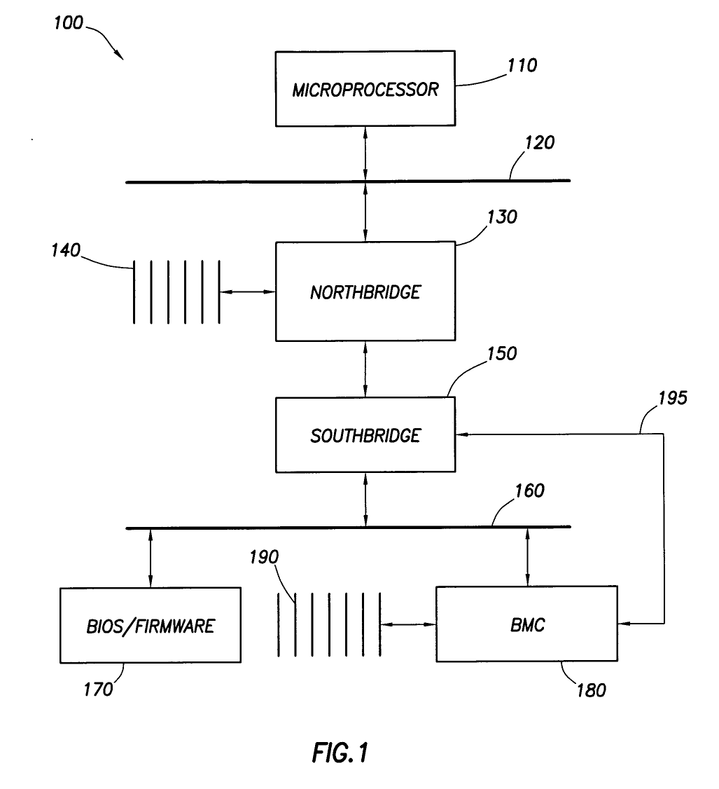

FIG. 1 illustrates an architecture for a motherboard, indicated generally by the numeral 100, for use in an information handling system such as a server system. The architecture shown in FIG. 1 is for exemplary purposes only and should be understood as depicting only one of the many possible architectures for motherboards. As shown in FIG. 1, motherboard 100 may include a microprocessor 110. Microprocessor 110 may act as the CPU for the motherboard. Microprocessor 110 may to a chip commonly referred to as the “Northbridge,” labeled 130 in FIG. 1, via a processor bus 120. Northbridge 130 typically manages communications between the CPU and other components of the information handling system, such as memory units. Thus, one or more memory units and a memory controller, indicated generally by the numeral 140, may couple to Northbridge 130. A chip known as the “Southbridge,” labeled 150 in FIG. 1, may also couple to Northbridge 130. Southbridge 150 typically implements slower services for the motherboard than implemented by Northbridge 130, such as power management and operation of the Peripheral Component Interface (PCI) bus. Southbridge 150 may couple via a Low Pin Count (LPC) bus 160 to a memory unit containing a BIOS 170. The BIOS is sometimes referred to as “firmware.” Northbridge 130 and Southbridge 150 are sometimes collectively referred to as the “chipset” for motherboard 100. However, should motherboard 100 include other or additional chips, these components could be part of the chipset as well.

A BMC 180 also may couple to the LPC bus 160, as indicated at the bottom of FIG. 1. A controller and one or more memory units, indicated generally by the numeral 190, couple to BMC 180. Memory unit or units 190 may preferably be non-volatile memory units. BMC 180 may have its own power supply, although no power supply is indicated in FIG. 1. As discussed previously in this disclosure, BMC 180 will typically manage the interface between system management software and platform hardware. Different sensors built into the information handling system may report to BMC 180 on parameters relevant to the status and operability of the information handling system, such as temperature, cooling fan speeds, and various voltages. If BMC 180 detects a deviation in any monitored parameter from desired preset limits, it may send an alert to the user or system administrator. BMC 180 may thus couple to a number of hardware components and a network, not shown in FIG. 1, to monitor these parameters and activate alerts if necessary.

The architecture for motherboard 100 shown in FIG. 1 does not include sideband signal capability between microprocessor 110 and Southbridge 150. All communications must travel through the main transport link, and an information handling system incorporating motherboard 100 cannot rely upon sideband signals for reports of recoverable errors. Moreover, because recoverable errors are correctible, this information handling system generally will not notify the user that such an error has occurred unless it periodically polls for errors. Thus, an information handling system incorporating motherboard 100 might be designed to report recoverable errors by employing BIOS 170 to perform periodic scans, such as periodic SMIs. Likewise, an information handling system incorporating motherboard 100 might be designed to rely on the OS residing for the information handling system to invoke the periodic scans. These methods, however, are not without their drawbacks, as discussed previously in this disclosure. For example, the OS typically cannot identify which component is the source of the recoverable error because OS packages are generic and do not include maps of the architecture of the particular systems on which they reside. Moreover, the OS logs recoverable errors in the machine check status register (which may not be local to the component causing the error) and then clears the machine check status register.

Instead of relying on the OS or on BIOS 170 alone to manage periodic scans, information handling systems incorporating motherboard 100 may instead rely upon BMC 180 to invoke periodic soft SMIs. That is, once the information handling system is up and running, BMC 180 may invoke a soft SMI after a predefined period of time. An interrupt request line 195 between BMC 180 and the chipset on motherboard 100, can be made available for invoking the soft SMI. General Purpose Input Output (GPIO) ports, not shown in FIG. 1, can be configured to permit communications between BIOS 170 and BMC 180. When BMC 180 invokes the soft SMI, BIOS 170 will look for recoverable errors by reading, for example, the status register of the chipset, memory status register, and/or the status register of microprocessor 110. If BIOS 170 finds no errors in the status register(s), BIOS 170 will communicate the lack of errors to BMC 180. If BIOS 170 does find an error, BIOS 170 will communicate the error to BMC 180 and clear the status register containing the error. BIOS 170 may also log the error via BMC 180 in memory unit 190, typically in a non-volatile System Event Log. Because BIOS 170 is familiar with the architecture of motherboard 100, BIOS 170 may identify in the log the location of the source of the recoverable error.

The period at which BMC 180 invokes the soft SMI can be preset to any period desired by the manufacturer or user. For example, as we discussed previously in this disclosure, some OS versions perform periodic scans of a system's machine check status register once per minute. Thus, the period at which BMC 180 invokes the soft SMI may be set at less than one minute so that BIOS 170 checks the status registers more frequently than the resident OS performs its scan, thereby reducing the risk that the OS will clear errors from the machine check status register before BIOS 170 can detect them. BMC 180 may even invoke the soft SMI frequently enough to prevent the OS from ever detecting any errors. However, the period between soft SMIs should be great enough to avoid tying up BIOS 170 and BMC 180 unnecessarily and thereby degrading system performance.

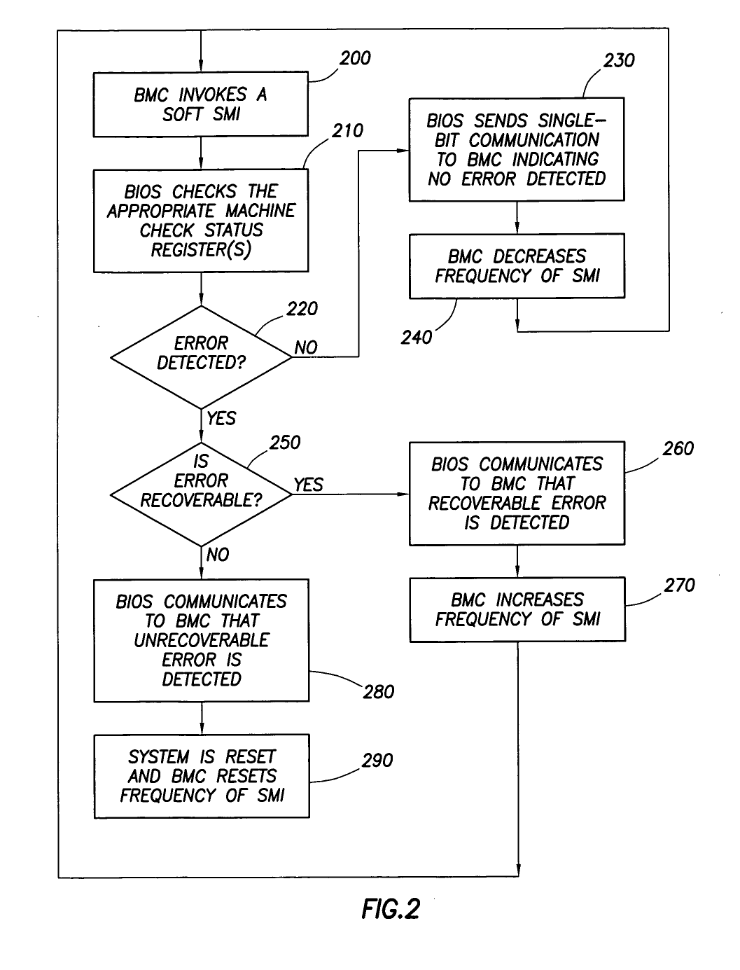

Alternatively, BMC 180 may adaptively change the frequency of the soft SMI after learning the error status from BIOS 170. FIG. 2 includes a flowchart illustrating a possible method for adaptively changing the frequency of the soft SMI. As shown in block 200 of the flowchart, BMC 180 may first invoke a soft SMI. BIOS 170 may then check the appropriate machine check status register(s), as shown in block 210 of the flowchart. BIOS 170 will determine whether it has located an error, as stated in block 220. If BIOS 170 does not detect any errors, BIOS 170 will send a single-bit communication to BMC 180 indicating no error was detected, as indicated in block 230. As block 240 of the flowchart shows, BMC 180 can then decrease the frequency at which it invokes the soft SMI. If, instead, BIOS 170 detects an error, BIOS 170 will next determine whether the error is recoverable. If BIOS 170 detects one or more recoverable errors, BIOS 170 will communicate that fact to BMC 180, as shown in block 260. BMC 180 can increase the frequency at which it invokes the soft SMI, as shown in block 270. If, however, BIOS 170 detects unrecoverable errors, it will communicate that fact to BMC 180. At that point, the entire system can be reset, and the frequency of the soft SMI can be reset back to a default setting, for example, as shown in block 290.

The generation of soft SMIs can be controlled using a system timer. The frequency of errors will usually increase or decrease in steps, so no extreme changes in the frequency of the soft SMI will be necessary to capture the correct error status for the system. For a system that adaptively changes the frequency of soft SMIs, however, the user or manufacturer should set a predetermined minimum and maximum values for the frequency at which BMC 180 can invoke any SMIs.

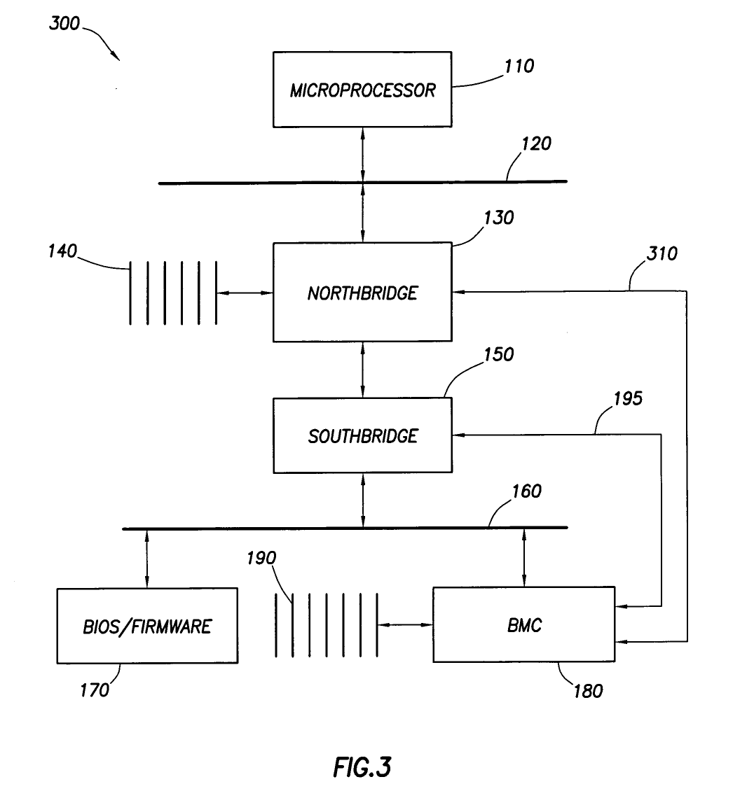

FIG. 3 illustrates an alternative architecture for a motherboard, indicated generally by the numeral 300, for use in an information handling system such as a server system. The architecture depicted in FIG. 3 is similar to that depicted in FIG. 1. Thus, like components in both figures are identified by the same reference characters. In motherboard 300, however, BMC 180 and the chipset, or even just Northbridge 130 may be coupled via an Inter-Interconnect (I²C) bus 310, as shown in FIG. 3. Motherboard 300 may also be designed to permit the status register for memory unit 140 to be shadowed or tracked by the chipset. In particular, motherboard 300 may be designed to permit Northbridge 130 to shadow the status register for memory unit 140 in its own status register. Thus, BMC 180 may scan Northbridge 130's status register via I²C bus 310 and determine if any recoverable errors for memory unit 140 have occurred. If BMC 180 detects a recoverable memory error, it may invoke a soft SMI to command BIOS 170 to log the recoverable error. If, however, BMC 180 does not detect a recoverable memory error, it will not disturb the operation of BIOS 170. Thus, the load on BIOS 170 may be reduced, as it is only required to act upon real errors previously detected by BMC 180. In certain systems, BMC 180 may log recoverable errors. However, for many systems, BIOS 170 may remain the more efficient choice for logging recoverable errors because an algorithm is already implemented in a typical BIOS to determine the cause of the error and the location of the component responsible for the error. Thus, if BMC 180 informs BIOS 170 that it has detected an error by generating a soft SMI, BIOS 170 can determine the cause of the error and log that information. The frequency at which BMC 180 scans Northbridge 130's machine check status may be predetermined. Alternatively, the frequency may be adaptively altered, as described previously in this disclosure. For example, the frequency may be increased if single-bit errors are detected or decreased if no errors are detected.

Although the present disclosure has described a system and method that may include adaptive changes to time interval between periodic scans by BIOS 170 and/or BMC 180 in response to detected errors, other factors may be used to adjust the frequency of those scans. For example, the load experienced by the component performing the scan, be it BIOS 170 or BMC 180, can influence the periodicity of the scans. If component performing the scan is overloaded with other tasks, for example, the frequency of the scans can be reduced to decrease the load on that component. Although the present disclosure has been described in detail, various changes, substitutions, and alterations can be made hereto without departing from the spirit and scope of the invention as defined by the appended claims.

What is claimed is:

1. A method for logging recoverable errors in an information handling system, comprising the steps of:
invoking a System Management Interrupt (SMI) periodically,
scanning a status register to detect whether a recoverable error has occurred,
logging a recoverable error, if a recoverable error is detected, wherein logging a recoverable error includes logging in a non-volatile memory unit associated with a baseboard management controller information that indicates a source of the recoverable error and that source's location, and
transmitting a communication indicating that no recoverable errors have occurred, if no recoverable errors are detected.

2. The method for logging recoverable errors of claim 1, wherein the step of invoking a SMI comprises invoking an interrupt using the baseboard management controller.

3. The method for logging recoverable errors of claim 1, wherein the step of scanning a status register to detect whether a recoverable error has occurred includes the step of scanning a status register using a Basic Input Output System (BIOS) stored in a memory unit in the information handling system.

4. The method for logging recoverable errors of claim 1, wherein the step of scanning a status register to detect whether a recoverable error has occurred includes the step of scanning a status register using the BMC.

5. The method for logging recoverable errors of claim 1, wherein the step of scanning a status register to detect whether a recoverable error has occurred includes the step of scanning a processor status register associated with a central processing unit.

6. The method for logging recoverable errors of claim 1, wherein the step of scanning a status register to detect whether a recoverable error has occurred includes the step of scanning a chipset status register associated with a chipset.

7. The method for logging recoverable errors of claim 1, wherein the step of scanning a status register to detect whether a recoverable error has occurred includes the step of scanning a memory status register associated with at least one memory unit coupled to a chipset.

8. The method for logging recoverable errors of claim 1, further comprising:
documenting recoverable errors arising from errors during operation of at least one memory unit associated with a chipset in a memory unit status register, and
tracking in a chipset status register any recoverable errors documented in the memory unit status register.

9. The method of claim 8, wherein scanning a status register to detect whether a recoverable error has occurred comprises scanning the chipset status register to detect whether a recoverable error has occurred.

10. The method of claim 1, further comprising altering how often the SMI is periodically invoked based on an event during operation of the information handling system.

11. The method of claim 10, wherein altering how often the SMI is periodically invoked based on an event during operation of the information handling system comprises altering how often the SMI is periodically invoked based on whether a recoverable error has been detected.

12. The method of claim 1, further comprising altering how often the SMI is periodically invoked based on a change in operation of the information handling system.

13. The method of claim 12, wherein the step of altering how often the SMI is periodically invoked based a change in operation of the information handling system comprises altering how often the SMI is periodically invoked based on a change in workload for a Basic Input Output System stored in the information handling system.

14. A system for logging recoverable errors, comprising:
a central processing unit,
a chipset coupled to the central processing unit,
at least one chipset memory unit coupled to and associated with the chipset,
at least one firmware memory unit containing a Basic Input Output System (BIOS), wherein the at least one firmware memory unit is coupled to the at least one chipset, and
a baseboard management controller (BMC) coupled to the chipset and to the at least one firmware memory unit, wherein the BMC can invoke an interrupt that requires the BIOS to check for recoverable errors and log any detected recoverable errors,
at least one BMC memory unit coupled to and associated with the BMC, wherein the at least one BMC memory unit can store a log of detected recoverable errors.

15. The system for logging recoverable errors of claim 14, further comprising an interrupt request line that couples the BMC to the chipset, wherein the BMC can transmit an interrupt through the interrupt request line to the chipset.

16. The system for logging recoverable errors of claim 14, further comprising a memory status register associated with the at least one chipset memory unit, wherein the BIOS may check the memory status register to check for recoverable errors.

17. The system for logging recoverable errors of claim 14, further comprising a processor status register associated with the central processing unit, wherein the BIOS may check the processor status register to check for recoverable errors.

18. The system for logging recoverable errors of claim 14, further comprising a chipset status register associated with the chipset, wherein the BIOS may check the chipset status register to check for recoverable errors.

19. A system for logging recoverable errors, comprising:
a central processing unit,
a chipset coupled to the central processing unit,
at least one chipset memory unit coupled to and associated with the chipset, wherein the at least one chipset memory unit is associated with a memory status register,
a chipset status register associated with the chipset, wherein the chipset status register may track the contents of the memory status register,
at least one firmware memory unit containing a Basic Input Output System (BIOS), wherein the at least one firmware memory unit is coupled to the at least one chipset,
a baseboard management controller (BMC) coupled to the chipset and to the at least one firmware memory unit, wherein the BMC can invoke an interrupt, check for recoverable errors in the chipset status register, and require that the BIOS log any detected recoverable errors, and
at least one BMC memory unit coupled to and associated with the BMC, wherein the at least one BMC memory unit can store a log of detected recoverable errors.

20. The system for logging recoverable errors of claim 19, further comprising an Inter-Interconnect bus that couples the BMC to the chipset.
